(19) United States
(12) Patent Application Publication
(10) Pub. No.: US 2017/0154481 A1
(43) Pub. Date: Jun. 1, 2017

(54) VEHICLE ABNORMAL SOUND IDENTIFICATION SYSTEM CAPABLE OF IDENTIFYING ABNORMAL SOUND

(71) Applicants: Inventec (Pudong) Technology Corp., Shanghai (CN); Inventec Corporation, Taipei (TW)

(72) Inventors: Po-Jui Chen, Taipei (TW); Di-Gu Yao, Taipei (TW); Ya-Hsuan Chang, Taipei (TW)

(21) Appl. No.: 15/086,075

(22) Filed: Mar. 31, 2016

(30) Foreign Application Priority Data
Nov. 30, 2015 (CN) 201510854535.X

(51) Int. Cl. G07C 5/08; G01M 17/007; G07C 5/00; F02D 41/22

(52) U.S. Cl. CPC G07C 5/0841; F02D 41/22; G01M 17/007; G07C 5/0816; G07C 5/006

(57) ABSTRACT

A vehicle abnormal sound identification system includes a database and at least one vehicle sound processing system. The database stores a vehicle sound comparison file having abnormal sound data and normal sound data of different parts of a vehicle under different conditions. Each processing system includes a plurality of sound sensors, a vehicle computer and a storage device disposed in the vehicle. The plurality of sound sensors receives sound generated from different parts of the car. The vehicle computer processes the sound collected by the plurality of sound sensors to generate a plurality of sound character data, and uploads the sound character data to the database. The database updates the comparison file according to the sound character data.

### BACKGROUND OF THE INVENTION

1. Field of the Invention

This invention relates to a vehicle abnormal sound identification system, especially relates to a vehicle abnormal sound identification system that is able to share a vehicle sound comparison file through database.

2. Description of the Prior Art

In prior art, electronic devices are usually used to test the conditions of crucial parts of vehicles, such as battery, engine oil, and engine, and the electronic devices may notify the driver by emitting signal light when abnormal conditions of the crucial parts are detected. However, when a vehicle has a breakdown, it may also be caused by other different parts of the vehicle without being detected by any electronic devices. Therefore, it is still difficult to understand the root cause of the breakdown by only a few signal lights.

Since the drivers may not have complete knowledge about the structures of their vehicles, the drivers may need to send their vehicles to the repair shop and have professional technicians examining their vehicles when the vehicles are broken-down. To prevent unnecessary disassembling of the vehicles, the technicians may identify the root cause by checking abnormal sound generated by the vehicles first, and only focus on parts that may potentially have issues. However, vehicles of different brands or different versions may generate different abnormal sound even if the cause of abnormal sound is very similar. Therefore, even for a professional technician, it could be difficult to identify the root cause correctly. Also, different technicians may have different experiences and different opinions so misjudgments are still common due to limited personal experiences. Furthermore, since the drivers may not have enough related knowledge to identify the root cause, the drivers have to rely on technicians' judgment to make replacements on the vehicles. However, the replacements may fail to solve the issue completely, resulting in conflicts and mistrust between the drivers and the technicians.

### SUMMARY OF THE INVENTION

One embodiment of the present invention discloses a vehicle abnormal sound identification system. The vehicle abnormal sound identification system includes a database and at least one vehicle sound processing system. The database stores a first vehicle sound comparison file having abnormal sound data and normal sound data of different parts of a vehicle under different conditions. Each of the vehicle sound processing system includes a sound sensor, a vehicle computer, and a storage device. The sound sensor is disposed in a part of the vehicle and receives sound generated from the part of the vehicle. The vehicle computer is disposed in the vehicle. The vehicle computer processes the sound collected by the sound sensor to generate sound character data and uploads the sound character data to the database. The database updates the first vehicle sound comparison file according to the sound character data. The storage device is disposed in the vehicle and stores the sound character data.

Another embodiment of the present invention discloses a method for identifying vehicle abnormal sound. The method includes a database storing a first vehicle sound comparison file having abnormal sound data and normal sound data of different parts of a vehicle under different conditions, a sound sensor receiving sound generated from apart of a vehicle, a vehicle computer processing the sound collected by the sound sensor to generate sound character data, storing the sound character data in a storage device, the vehicle computer uploading the sound character data to the database, and the database updating the first vehicle sound comparison file according to the sound character data. The sound sensor, the vehicle computer and the storage device are disposed in the vehicle.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a vehicle abnormal sound identification system according to one embodiment of the present invention.

FIG. 2 shows a flow chart of a method for identifying vehicle abnormal sound according to one embodiment of the present invention.

### DETAILED DESCRIPTION

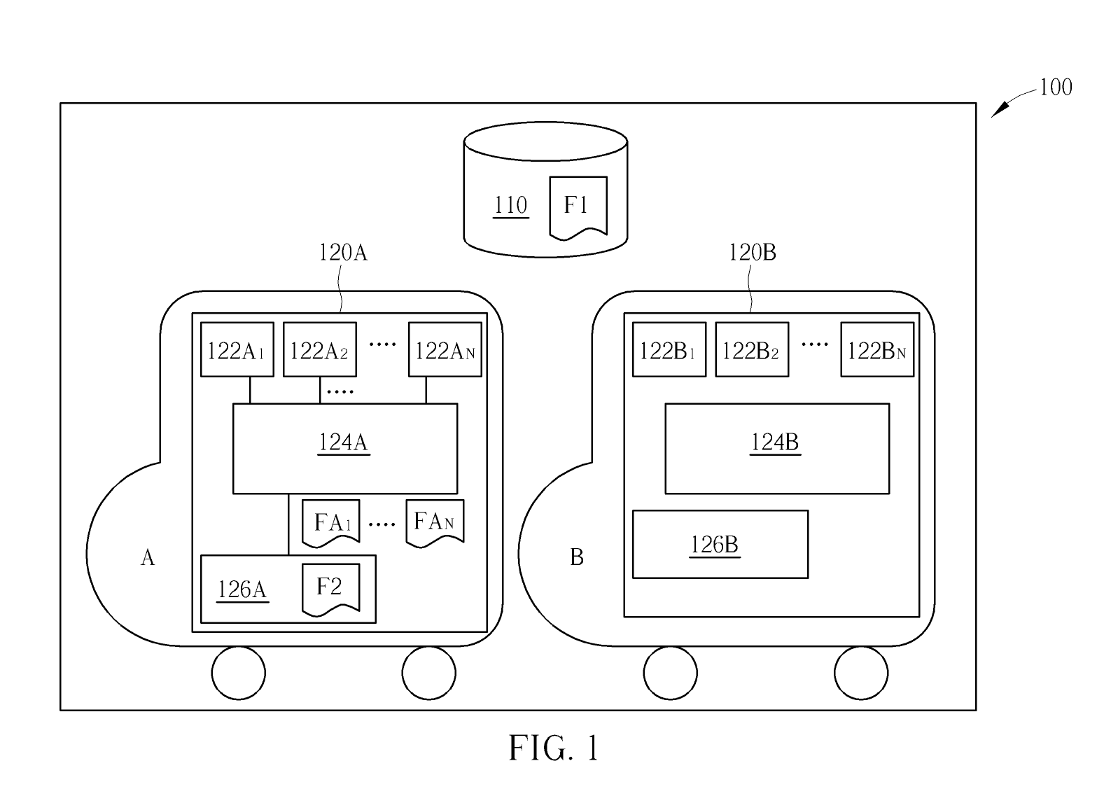

FIG. 1 shows a vehicle abnormal sound identification system 100 according to one embodiment of the present invention. The vehicle abnormal sound identification system 100 includes a database 110, and vehicle sound processing systems 120A and 120B.

The database 110 stores a first vehicle sound comparison file F1. The first vehicle sound comparison file includes abnormal sound data and normal sound data of different parts of vehicles under different conditions. Since different parts of the vehicle may generate different sound when the vehicle functions normally and when the vehicle functions abnormally, the possible root causes may be identified by identifying the sound generated by each part of the vehicle. For example, if the vehicle generates a clinking sound, it may suggest that the support rack of the engine has been worn out or that the bearing pad of front suspension or back suspension is damaged, or the automatic transmission fluid level is too low. If the vehicle generates a booming sound, such as “woo-wang”, it may suggest that the ball bearing of wheel, compressor, or water pump has defect. Also, if the vehicle generates a whizzing sound, it may suggest that the drive belt of fan may be worn out or loose.

Table 1 shows part of the content of the first vehicle sound comparison file F1 according to one embodiment of the present invention.

TABLE 1

| condition | | abnormal | |
|---|---|---|---|
| of the | part of the | sound/normal | |
| vehicle | vehicle | sound | possible situations |
| moving | wheel | rustling sound | The vehicle may be |
| | | | normal. |
| moving | wheel | clinking sound | The bearing pad of |
| | | | suspension may be |
| | | | damaged. |
| turning | hood | whizzing sound | The drive belt of fan |
| | | | may be worn out or |
| | | | loose. |
| moving | wheel | tat-tat sound | The cardan of drive |
| | | | shaft is damaged or |
| | | | contains little rocks. |
| moving | hood | humming sound | The plastic element or |
| | | | the metal element |
| | | | beneath of the engine is |
| | | | loose, or the support |
| | | | rack of the engine is |
| | | | loose. |
| moving | hood | booming sound | The ball bearing of |
| | | | wheel, compressor, or |
| | | | water pump has defect. |
| moving | hood | thudding sound | The bearing or the valve |
| | | | of engine is damaged. |

According to table 1, the possible reason that causes the abnormal sound may be identified according to the types of the sound generated by different parts of the vehicle under different conditions. In addition, the first vehicle sound comparison file F1 may further include the normal sound data of different parts of the vehicle when the vehicle functions normally. Since the structures of vehicles of different brand and/or different versions may be different from each other, the sound generated by the vehicles may also be different. Therefore, the first vehicle sound comparison file F1 may record the vehicle sound comparison file of one specific brand and version of car.

The vehicle sound processing system 120A includes N sound sensors 122A₁, 122A₂ to 122A_{N}, a vehicle computer 124A, and a storage device 126A, where N is a positive integer. The sound sensors 122A₁, 122A₂ to 122A_{N} are disposed in different parts of the vehicle A, such as the hood, the wheel, and the chassis, and can receive the sound generated by each part of the vehicle A. The vehicle computer 124A is also disposed in the vehicle A, and can process the sound collected by the sound sensors 122A₁ to 122A_{N} to generate sound character data FA₁ to FA_{N}. The storage device 126A is disposed in the vehicle A, and can store the sound character data FA₁ to FA_{N}. The vehicle sound processing system 120A and the vehicle sound processing system 120B have similar structures and operational principles. That is, the vehicle sound processing system 120B may also include N sound sensors 122B₁, 122B₂ to 122B_{N}, a vehicle computer 124B, and a storage device 126B.

Since some of the abnormal sound may only occur when an engine of the vehicle is in a power on mode or during a predetermined time period after the engine of the vehicle is powered off, the sound sensors 122A₁, 122A₂ to 122A_{N} may be designed to receive the sound generated from each part of the vehicle when the engine of the vehicle is in the power on mode and/or during the predetermined time period after the engine of the vehicle is powered off.

In addition, since the sound sensors 122A₁, 122A₂ to 122A_{N} can continuously receive the sound generated close to them, the vehicle computer 124A may have to process the sound collected by the sound sensors 122A₁, 122A₂ to 122A_{N} before it can generate the sound character data for identifying the characteristics the sound. For example, the vehicle computer 124A may perform operations, such as pre-emphasizing, frame blocking, and de-noise, to preprocess the sound, then the vehicle computer 124 may derive the characteristic parameters, such as the volume, the pitch, Mel-Frequency Cepstral Coefficients (MFCCs), Linear Predictive Coefficients (LPC), and zero-crossing rate (ZCR), and then the vehicle computer 124 may perform the end-point detection to derive the sound segment for comparison.

In some embodiments of the present invention, the vehicle computer 124A can upload the sound character data FA₁ to FA_{N} to the database 110, and the database 110 can calculate the similarities between the sound character data FA₁ to FA_{N} and sound data in the first vehicle sound comparison file F1. If a similarity between a piece of sound character data of the sound character data FA₁ to FA_{N} and a piece of abnormal sound data in the first vehicle sound comparison file F1 is greater than a predetermined percentage, such as greater than 90%, then the vehicle A may have already encountered some issues. In this case, vehicle abnormal sound identification system 100 may output a warning signal to the vehicle A. The method for calculating the similarities may include calculating the similarities of the waveforms of the sound data.

For example, when the database 110 receives the sound character data FA₁, the database 110 can calculate the similarity between the sound character data FA₁ and all the sound data of the first vehicle sound comparison file F1, if the similarity between the sound character data FA₁ and a clinking sound generated near the wheel while the vehicle is moving is greater than the predetermined percentage, then the vehicle abnormal sound identification system 100 may inform the vehicle A of the possible damage on the bearing of suspension by outputting a warning signal to the vehicle A. Consequently, the driver of the vehicle A is able to collect more information related to the vehicle and the professional technician may also perform the corresponding testing according to the warning signal, which helps to increase the possibility to solve the issue.

In addition, the database 110 can also update the first vehicle sound comparison file F1 according to the received sound character data FA₁ to FA_{N}. For example, the first vehicle sound comparison file F1 may not include the sound character data FA_{N}, which is a ping sound, previously. After examination, if the technician confirms that the reason causing the ping sound is due to the use of gasoline of inferior quality, then the technician may upload the ping sound data and the reason causing the ping sound to the database 110. The vehicle abnormal sound identification system 100 can use the database 110 with the updated first vehicle sound comparison file F1 to notify a vehicle B to change gasoline by outputting a warning signal.

In some embodiments of the present invention, the storage device 126A may store a second vehicle sound comparison file F2. The second vehicle sound comparison file F2 may be stored in the storage device 126A when the vehicle A is assembled in the factory. In this case, the vehicle computer 124 can calculate the similarities between the sound character data FA₁ to FA_{N} and sound data in the second vehicle sound comparison file F2 before uploading the sound character data FA₁ to FA_{N} to the database 110. If a similarity between a piece of sound character data of the sound character data FA₁ to FA_{N} and a piece of abnormal sound data in the second vehicle sound comparison file F2 is greater than the predetermined percentage, then the vehicle abnormal sound identification system 100 may output a warning signal to the vehicle A. If all similarities between the sound character data FA₁ to FA_{N} and the abnormal sound data in the second vehicle sound comparison file F2 are smaller than the predetermined percentage, then there may be some abnormal sound cannot be identified. In this case, the vehicle computer 124A can upload the unidentifiable abnormal sound data to the database 110 so that the database 110 can compare the abnormal sound data to the first vehicle sound comparison file F1 and/or the database 110 can be updated according to the upload data.

Since the vehicle sound processing systems 120A and 120B can upload the sound character data to the database 110 according to the aforesaid processes, the first vehicle sound comparison file F1 can keep updated. Similarly, the vehicle computer 124A may also download the updated first vehicle sound comparison file F1 to update the second vehicle sound comparison file F2 in the storage device 126A. Consequently, the experiences of different technicians can be shared, the possibility to solve issues can be increased, and the driver may also be aware of the possible reason causing the breakdown of the vehicle.

Furthermore, in some embodiments of the present invention, the vehicle computer 124A can upload the sound character data to the database 110 through Wireless Fidelity or mobile communication, such as the 3^{rd} generation mobile communication or the 4^{th} generation mobile communication. Also, the sound character data can also be exported through a corresponding wire when the vehicle is in a vehicle repair shop, and then uploaded to the database 110 by a computer.

Since the vehicle abnormal sound identification system 100 can be applied to cars of the same brand and same version, the first vehicle sound comparison file F1 in the database 110 can continuously collect the abnormal sound generated and reasons causing the abnormal sound from each car. Therefore, the manufacturer of the cars can improve design of next generation cars according to the reasons causing the abnormal sound to prevent the similar issues from happening again on the next generation cars, which may gain the trust of customers.

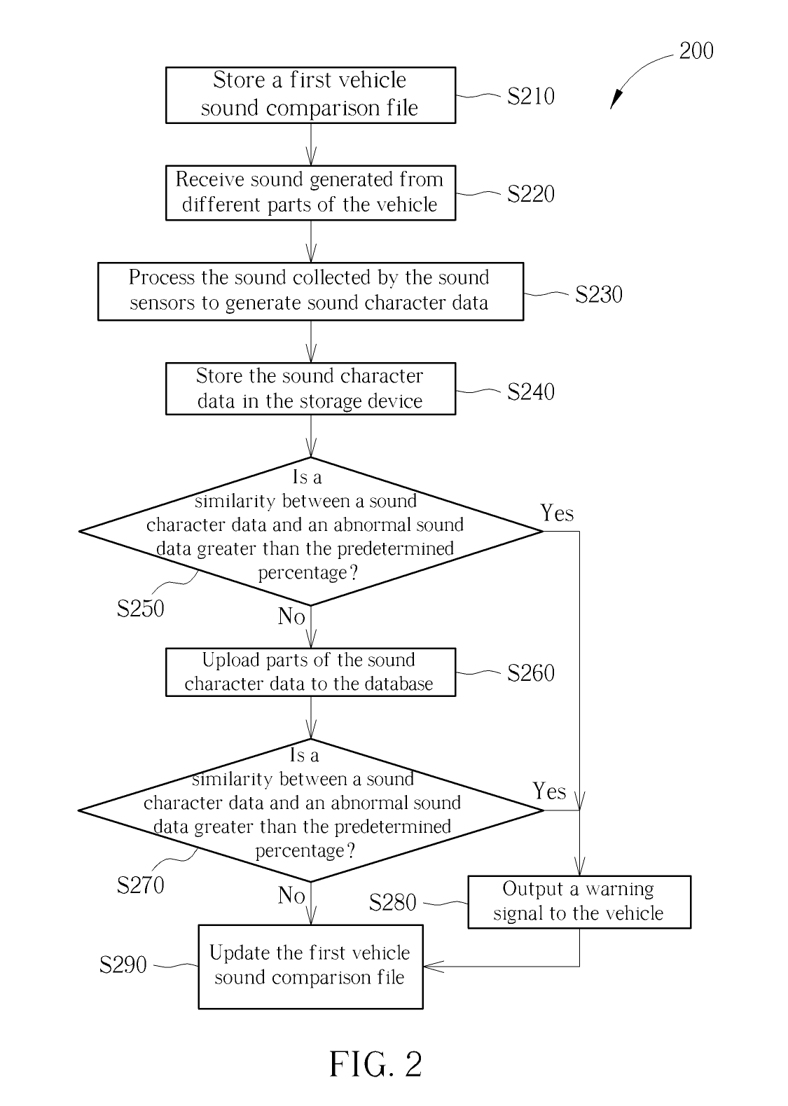

FIG. 2 shows a flow chart of a method 200 for identifying vehicle abnormal sound according to one embodiment of the present invention. The method 200 for identifying vehicle abnormal sound can be applied to the vehicle abnormal sound identification system 100, and can include steps S210 to S290.

S210: the database 110 stores a first vehicle sound comparison file F1;

S220: the sound sensors 122A₁ to 122A_{N} receive sound generated from different parts of the vehicle A;

S230: the vehicle computer 124A processes the sound collected by the sound sensors 122A₁ to 122A_{N} to generate sound character data FA₁ to FA_{N};

S240: store the sound character data FA₁ to FA_{N} in the storage device 126A;

S250: the vehicle computer 124A uploads the sound character data FA₁ to FA_{N} to the database 110, if a similarity between a piece of sound character data of the sound character data FA₁ to FA_{N} and a piece of abnormal sound data in the second vehicle sound comparison file F2 is greater than a predetermined percentage, then go to step S280, else go to step 5260;

S260: the vehicle computer 124A uploads parts of the sound character data FA₁ to FA_{N} to the database 110;

S270: the database 110 calculates similarities between the sound character data FA₁ to FA_{N} and sound data in the first vehicle sound comparison file F1, if a similarity between a piece of sound character data of the sound character data FA₁ to FA_{N} and a piece of abnormal sound data in the first vehicle sound comparison file F1 is greater than the predetermined percentage, then go to step S280, else go to step S290;

S280: output a warning signal to the vehicle A; and

S290: the database 110 updates the first vehicle sound comparison file F1 according to the sound character data FA₁ to FA_{N}.

In addition, in the method 200, the vehicle computer 124A can also update the second vehicle sound comparison file F2 according to the updated first vehicle sound comparison file F1 so that the second vehicle sound comparison file F2 can keep being updated to the latest version. However, the method 200 of the present invention is not limited to include all the aforesaid steps and is not limited to the aforesaid sequence. For example, the method 200 may skip step S250. In this case, the storage device 126A does not need to store the second vehicle sound comparison file F2 so the memory size can be saved.

By the method 200, the experiences of different technicians can be shared, the possibility to solve issues can be increased, and the driver can also be aware of the possible reason causing the breakdown of the vehicle.

In summary, according to the vehicle abnormal sound identification systems and the methods for identifying vehicle abnormal sound provided by the embodiments of the present invention, the database can store the vehicle sound comparison file, and the vehicle sound comparison file can be updated according to the abnormal sound collected from different vehicles and the reasons causing the abnormal sound examined by the technicians. Therefore, experiences of different technicians can be shared, which help to avoid the misjudgments caused by limited personal experience in the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A vehicle abnormal sound identification system, comprising:
a database configured to store a first vehicle sound comparison file having abnormal sound data and normal sound data of different parts of a vehicle under different conditions; and
at least one vehicle sound processing system, each comprising:
a sound sensor disposed in a part of the vehicle, and configured to receive sound generated from the part of the vehicle;
a vehicle computer disposed in the vehicle, and configured to process the sound collected by the sound sensor to generate sound character data, and upload the sound character data to the database, wherein the database updates the first vehicle sound comparison file according to the sound character data; and
a storage device disposed in the vehicle, and configured to store the sound character data.

2. The vehicle abnormal sound identification system of claim 1, wherein:
the storage device is further configured to store a second vehicle sound comparison file; and
the vehicle computer is further configured to calculate similarities between the sound character data and different sound data in the second vehicle sound comparison file, if a similarity between a piece of sound character data and a piece of abnormal sound data in the second vehicle sound comparison file is greater than a predetermined percentage, then output a warning signal to the vehicle.

3. The vehicle abnormal sound identification system of claim 2, wherein the vehicle computer is further configured to download the first vehicle sound comparison file and update the second vehicle sound comparison file according to the first vehicle sound comparison file.

4. The vehicle abnormal sound identification system of claim 1, wherein the vehicle computer uploads the sound character data to the database through Wireless Fidelity, mobile communication, or a corresponding wire when the vehicle is in a vehicle repair shop.

5. The vehicle abnormal sound identification system of claim 1, wherein the database is further configured to calculate similarities between the sound character data and sound data in the first vehicle sound comparison file, if a similarity between a piece of sound character data and a piece of abnormal sound data in the first vehicle sound comparison file is greater than a predetermined percentage, then the vehicle abnormal sound identification system outputs a warning signal to the vehicle.

6. A method for identifying vehicle abnormal sound, comprising:
a database storing a first vehicle sound comparison file having abnormal sound data and normal sound data of different parts of a vehicle under different conditions;
a sound sensor receiving sound generated from a part of a vehicle;
a vehicle computer processing the sound collected by the sound sensor to generate sound character data;
storing the sound character data in a storage device;
the vehicle computer uploading the sound character data to the database; and
the database updating the first vehicle sound comparison file according to the sound character data;
wherein the sound sensor, the vehicle computer and the storage device are disposed in the vehicle.

7. The method for identifying the vehicle abnormal sound of claim 6, further comprising:
storing a second vehicle sound comparison file in the storage device;
the vehicle computer calculating similarities between the sound character data and different sound data in the second vehicle sound comparison file, if a similarity between a piece of sound character data and a piece of abnormal sound data in the second vehicle sound comparison file is greater than a predetermined percentage, then outputting a warning signal to the vehicle; and
the vehicle computer updating the second vehicle sound comparison file according to an updated first vehicle sound comparison file.

8. The method for identifying the vehicle abnormal sound of claim 6, wherein the vehicle computer uploads the sound character data to the database through Wireless Fidelity, mobile communication, or a corresponding wire when the vehicle is in a vehicle repair shop.

9. The method for identifying the vehicle abnormal sound of claim 6, further comprising:
the database calculating similarities between the sound character data and sound data in the first vehicle sound comparison file, if a similarity between a piece of sound character data and a piece of abnormal sound data in the first vehicle sound comparison file is greater than a predetermined percentage, then outputting a warning signal to the vehicle.

10. The method for identifying the vehicle abnormal sound of claim 6, wherein sound sensor receives the sound generated from the part of the vehicle when an engine of the vehicle is in a power on mode and/or during a predetermined time period after the engine of the vehicle is powered off.
